(19) United States
(12) Patent Application Publication
(10) Pub. No.: US 2007/0003035 A1
(43) Pub. Date: Jan. 4, 2007

(54) Auto phone dialing system for multiple phone service providers

(76) Inventors: Bin Zhu, El Monte, CA (US); Laurence Yalin Wang, El Monte, CA (US)

Correspondence Address: Raymond Y. Chan, 108 N. Ynez Ave., #128, Monterey Park, CA, 91754, US

(21) Appl. No.: 11/158,796

(22) Filed: Jun. 21, 2005

(51) Int. Cl. H04M 15/00

(52) U.S. Cl. 379/114.02

(57) ABSTRACT

An auto phone dialing system for multiple phone service providers includes a provider database for storing information of the phone service providers and a provider selection unit including a phone number reader adapted for reading a dialing number having a dialing code and a sorting selector linked to the phone number reader and arranged in such a manner that when dialing the dialing number, the sorting selector is adapted for sorting out the information of the phone service providers in the provider database with respect to the dialing code and selecting one of the phone service providers to make a call.

### BACKGROUND OF THE PRESENT INVENTION

1. Field of Invention

The present invention relates to a phone system, and more particularly to an auto phone dialing system for multiple phone service providers, wherein when a user dials a phone number, the auto phone dialing system recognizes the dialing code of the phone number and automatically selects the optimum phone service provider to make a connection while being cost effective.

2. Description of Related Arts

Phone system is considered as one of the public communication networks commonly used today. However, make domestic and international calls are painful for a user. As shown in FIG. 1, every time when the user makes a call, he or she merely research for a phone service provider which provides a better calling rate for the designated location. For example, the user merely uses the first phone service provider to make a domestic call and the second phone service provider to make an international call. It is worth to mention that when the user choose the first phone service provider, such as a calling card provider, the user must firstly enter the corresponding provider phone number and then a pin number before making the domestic call. In other words, the user must enter another provider phone number and another pin number before making the international number when the second phone service provider is selected.

Likewise, the user merely carries more than two calling cards from different phone service providers that the third phone service provider provides a better calling rate for Europe, the fourth phone service provider provides a better calling rate for Asia, and the fifth phone service provider provides a better calling rate for South America. Therefore, hundreds of phone service providers must be carefully picked by the user before making the corresponding call in order to save the phone bill. In other words, hundreds of provider phone numbers and corresponding pin numbers must be memorized and entered before making the phone call. Therefore, make domestic and international calls are painful for the user.

### SUMMARY OF THE PRESENT INVENTION

A main object of the present invention is to provide an auto phone dialing system for multiple phone service providers, wherein when a user dials a phone number, the auto phone dialing system recognizes the dialing code of the phone number and automatically selects the optimum phone service provider to make a connection while being cost effective.

Another object of the present invention is to provide an auto phone dialing system for multiple phone service providers, wherein information of the phone service providers, such as the provider phone numbers and the corresponding pin numbers, is preloaded in the dialing system either by the user or the system provider such that the user is able to make a call directly without entering any provider phone number and the corresponding pin number.

Another object of the present invention is to provide an auto phone dialing system for multiple phone service providers, wherein the dialing system can be updated by either the system provider or the user to obtain updated information of the phone service providers so as to maximize the saving of the phone bill.

Another object of the present invention is to provide an auto phone dialing system for multiple phone service providers, wherein the installation of the dialing system is easy and simple that by directly connecting the dialing system to the existing telephone such that the existing telephone does not require to alter its configuration in order to incorporate the dialing system with the existing telephone. Alternatively, the dialing system can be built-in with the telephone to minimize the connection therebetween.

Another object of the present invention is to provide an auto phone dialing system for multiple phone service providers, wherein the dialing system is easy to use by directly making a phone call. In other words, the user is able make a direct call without memorizing any accessing number and pin number to access the corresponding phone service provider before the call is made. Therefore, the dialing process of the present invention is simplified as a direct calling process.

Another object of the present invention is to provide an auto phone dialing system for multiple phone service providers, wherein no expensive or complicated configuration is required to employ in the present invention in order to achieve the above mentioned objects. Therefore, the present invention successfully provides an economic and efficient solution for providing a low calling cost for the user.

Accordingly, in order to accomplish the above objects, the present invention provides an auto phone dialing system for multiple phone service providers, comprising:

a service center comprising a provider database for storing information of the phone service providers; and

a provider selection unit, which is communicatively linked to the service center, comprising a phone number reader adapted for reading a dialing number having a dialing code and a sorting selector linked to the phone number reader and arranged in such a manner that when dialing the dialing number, the sorting selector is adapted for sorting out the information of the phone service providers in the provider database with respect to the dialing code and selecting one of the phone service providers to make a call.

The present invention further comprises a method of dialing a phone number through an auto phone dialing system for multiple phone service providers, comprising the steps of:

(a) storing information of the phone service providers in a provider database;

(b) receiving the phone number having a dialing code;

(c) sorting out the information of the phone service providers in the provider database with respect to the dialing code; and

(d) selecting one of the phone service providers to make a call with respect to the dialing code.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a conventional dialing system.

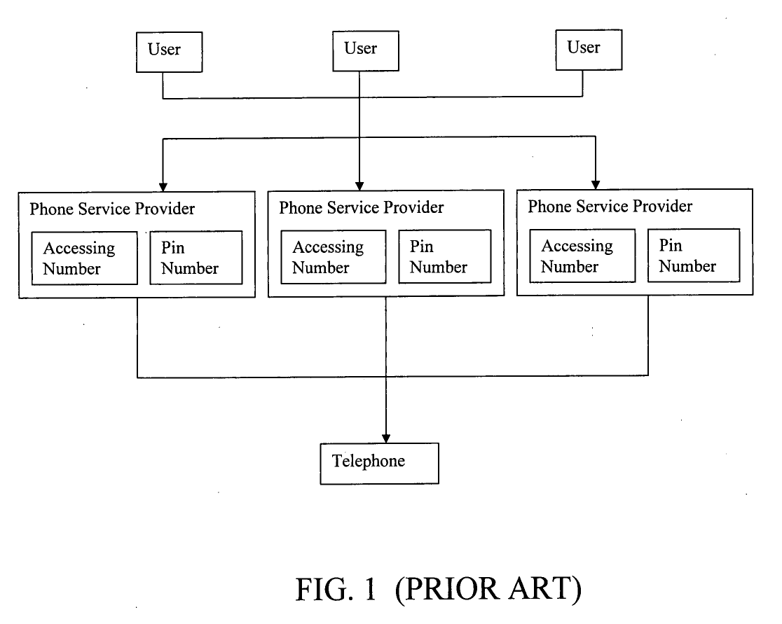

FIG. 2 is a block diagram of an auto phone dialing system for multiple phone service providers according to a preferred embodiment of the present invention.

FIG. 3 is a flow diagram of a method of dialing a phone number through the auto phone dialing system for multiple phone service providers according to the above preferred embodiment of the present invention.

FIG. 4 is a flow diagram of a method of making a call at the lowest calling rate from multiple phone service providers through the auto phone dialing system according to the above preferred embodiment of the present invention.

FIG. 5 is a perspective view of the auto phone dialing system according to a preferred embodiment of the present invention

### DETAILED DESCRIPTION OF THE PREFERRED EMBODIMENT

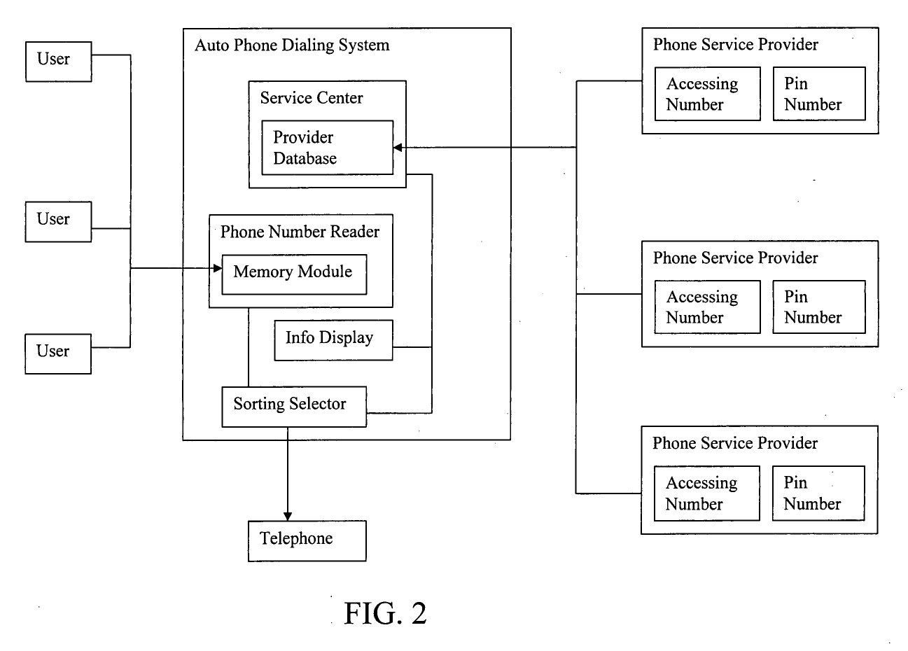

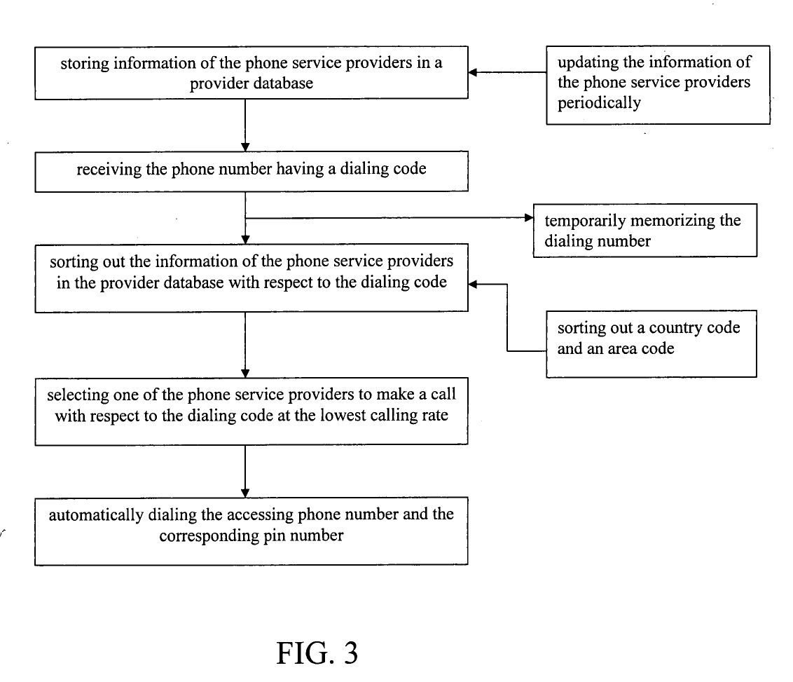

Referring to FIGS. 2 to 3 of the drawings, an auto phone dialing system for multiple phone service providers according to a preferred embodiment of the present invention is illustrated, wherein the auto phone dialing system is adapted for communicatively connecting to an existing telephone.

The auto phone dialing system comprises a service center comprising a provider database for storing information of the phone service providers, and a provider selection unit communicatively linked to the service center.

The provider selection unit comprises a phone number reader adapted for reading a dialing number having a dialing code and a sorting selector linked to the phone number reader and arranged in such a manner that when dialing the dialing number, the sorting selector is adapted for sorting out the information of the phone service providers in the provider database with respect to the dialing code and selecting one of the phone service providers to make a call.

As shown in FIG. 3, the present invention further provides a method of dialing a phone number through the auto phone dialing system for multiple phone service providers, comprising the following steps.

(1) Store information of the phone service providers in the provider database, wherein the information of the phone service providers contains a plurality of calling rates for different locations of each of the phone service providers.

(2) Receive the phone number having a dialing code.

(3) Sort out the information of the phone service providers in the provider database with respect to the dialing code.

(4) Select one of the phone service providers to make a call with respect to the dialing code at the lowest calling rate.

Accordingly, the dialing number includes the dialing code and a phone number wherein the dialing code includes an international code, a country code and an area code. In other words, when the user makes an international call, he or she must dial the international code, the country code, the area code and the phone number. For domestic or local call, the international code, the country code or area code can be omitted. Therefore, when the user makes a call, the phone service provider will charge the user with the calling rate with respect to the country code or the area code dialed by the user.

Each of the phone service providers provides a list of calling rates for different locations respectively such that the user is able to make a call to a desired location and pay the corresponding phone bill with respect to the calling rate. For example, the user is able to make a call to Canada with the calling rate of 10 cents per minute provided by the first phone service provider. When more than one phone service providers provide the same service, the user is able to selectively pick one of the lowest calling rates to make a call. For example, the user is able to choose the second phone service provider to make a call to Canada with the calling rate of 8 cents per minute so as to lower the phone bill.

It is worth to mention each of the phone service providers also provides an accessing code for accessing the respective phone service provider, wherein the accessing code contains an accessing phone number and a pin number such that the user must dial the accessing phone number and enter the pin number before making a call.

According to the present invention, the information of the phone service providers contains the accessing code of each of the phone service providers and the calling rates thereof. In other words, the accessing phone number, the corresponding pin number and the calling rates of each of the phone service providers are stored in the provider database. Accordingly, the information of the phone service providers can be pre-loaded in the provider database or manually input in the provider database by the user.

In order to obtain a cheaper calling rate, the present invention provides a system provider directly contacting with the phone service providers such that the system provider can pre-load the information of the phone service providers in the provider database for allowing the user to access. Therefore, the system provider is able to contract to ensure each of the phone service providers providing at least one calling rate with lower cost. In other words, the first phone service provider may provide a better calling rate for calling to Canada and the second phone service provider may provide a better calling rate for calling to Rome. It is worth to mention that the user is able to manually input the information of the phone service provider to obtain a better calling rate to overwritten the information in the provider database even though the information of the phone service provider is pre-loaded in the provider database. The user is able to buy or lease the auto phone dialing system of the present invention from the system provider. Otherwise, the auto phone dialing system is free for the user when the phone service providers will pay a predetermined amount of fees for the system provider.

Accordingly, the provider database is updated periodically to update the information of the phone service providers either by the system provider automatically or by the user.

In step (3), the method of the present invention further comprises the following steps.

(3.1) Sort out the information of the phone service providers in the provider database with respect to the country code.

(3.2) Sort out the information of the phone service providers in the provider database with respect to the area code.

(3.3) Determine which phone service provider in the provider database providing the lowest calling rate with respect to the country code and the area code.

The phone number reader is a number reader to read the country code, the area code, and the phone number when the user dials the dialing number. In other words, when the user firstly dials the country code, the phone number reader is adapted to recognize there is an international call. Likewise, when the user firstly dials the area code, the phone number reader is adapted to recognize there is a domestic call. If the user directly dials the phone number without any country code or area code, the phone number reader recognize there is a local call.

The sorting selector is embodied as a sorting device to sort out the phone service providers in the provider database before completing the dialing number. For example, when the user wants to make an international call to Rome, he or she must dial the corresponding country code. Once the country code is entered and read by the phone number reader, the sorting selector sorts out all the phone service providers with the calling rates calling to Rome. Then, when the area code is entered and read by the phone number reader, the sorting selector sorts out all the phone service providers with the calling rates calling to Rome with respect to the area code. The sorting selector will compare the calling rates of all the phone service providers with respect to the country code and area code and find the lowest calling rate of the corresponding phone service provider to make a call.

The step (4) of the present invention further comprises a following step.

(4.1) Automatically dial the accessing code, including the accessing phone number and the corresponding pin number, to access the respective phone service provider selected by the sorting selector.

According to the preferred embodiment, the user only dials the country code, the area code and the phone number without dialing any accessing phone number and corresponding pin number. Once the sorting selector selects the phone service provider, the sorting selector sends a dialing signal to the telephone to auto-dial the accessing number and the corresponding pin number.

In addition, some phone service providers provide a multi-language selection for the user to select a desired language, such as English, Chinese, or Spanish. In other words, the user will need to select one of the languages after accessing the respective phone service provider. Accordingly, the auto phone dialing system will help the user to preset the desired language in the provider database such that the user does not need to select the language when making the call. For example, the user presets English as a desired language of the phone service provider in the provider database, such that when the respective phone service provider is accessed, English language is automatically selected to make the call.

For example, the information of five phone service providers is stored in the provider database wherein the first, second and third phone service providers are able to provide a better calling rate for international call while the fourth and fifth phone service providers are able to provide a better calling rate for long distance call, such that the provider selection unit is adapted to selectively choose one of the phone service providers to make a call with the lowest calling rate thereof. Accordingly, when the user dials “011” as an international code, the phone number reader automatically reads the “011” and the sorting selector recognizes there is an international call, such that the sorting selector sorts out the phone service providers and eliminates the fourth and fifth phone service providers. Then, when the user continuously dials “86” as the country code and read by the phone number reader, the sorting selector recognizes the call is calling to China and sorts out the first phone service provider providing the lowest calling rate to China. Therefore, after the user dials the dialing number, the auto phone dialing system will automatically not only access the first phone service provider (including the accessing phone number and the pin number thereof) but also dial the dialing number to China. In other words, the user is able to make a direct call to China using the first phone service provider without actually accessing the first phone service provider. Likewise, when the user makes a domestic call, the sorting selector will eliminate the first, second and third phone service providers and will choose one of the fourth and fifth phone service providers based on the calling rate.

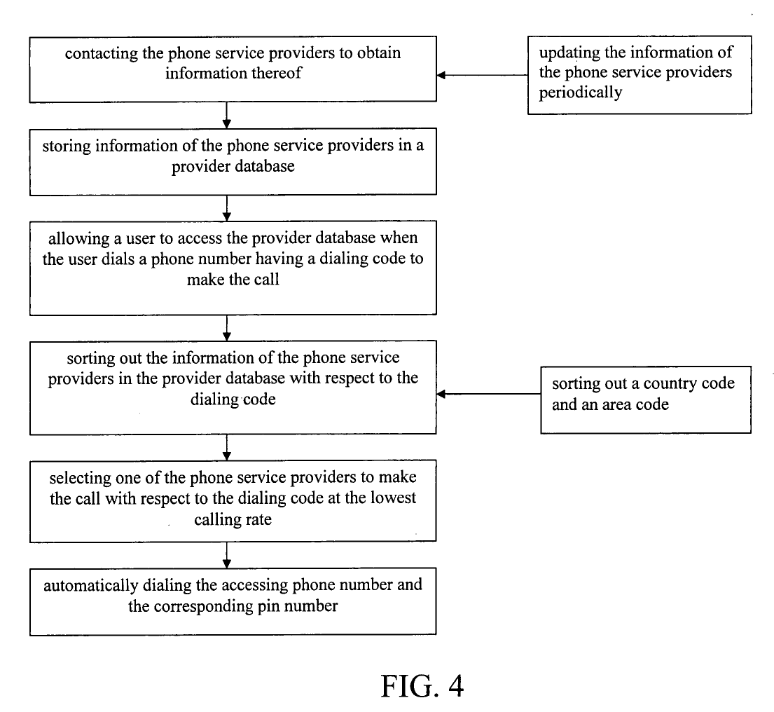

As shown in FIG. 4, the present invention further provides a method of making a call at the lowest calling rate from multiple phone service providers through the auto phone dialing system, comprising the following steps.

(A) Contact the phone service providers to obtain information thereof, wherein the information of the phone service providers contains a plurality of calling rates for different locations of each of the phone service providers. The auto phone dialing system has enough bargaining power to negotiate with the phone service providers to obtain a special calling rate from each of the phone service providers, especially when more users join to use the auto phone dialing system.

(B) Store information of the phone service providers in a provider database. The information is pre-loaded in the provider database such that the user does not need to input any information by himself or herself. In addition, the user should obtain an info list, such as a list of calling rates for different locations, in order to read the information.

(C) Allow the user to access the provider database when the user dials a phone number having a dialing code to make a call. Accordingly, when the auto phone dialing system is linked to the telephone, the user is able to access the provider database by making a direct phone call.

(D) Sort out the information of the phone service providers in the provider database with respect to the dialing code. The auto phone dialing system will sort out the phone service providers when dialing the phone number.

(E) Select one of the phone service providers to make a call with respect to the dialing code at the lowest calling rate. With respect to the phone number, the auto phone dialing system will automatically select one of phone service providers at the lowest calling rate.

(F) Automatically dial the accessing phone number and the corresponding pin number to access the respective phone service provider. When the phone service provider requires the user to input the accessing phone number and the pin number before making the call, the auto phone dialing system will automatically dial to access the phone service provider so as to simplify the dialing process of the phone call. It is worth to mention that when a multi-language selection is needed to be selected by the user, the auto phone dialing system will help the user to preset the desired language in the provider database so as to eliminate the step of language selection.

The phone number reader further comprises a memory module communicatively linked to the sorting selector for temporarily memorizing the dialing number to allow the sorting selector sorting out the phone service providers in the provider database and completing the dialing number simultaneously. The memory module will save the country code, the area code and the phone number to speed up the dialing process before completing the dialing process of the accessing number and the pin number. In other words, the user is able to simply dial the country code, the area code and the phone number all at once without lagging the time for dialing.

The auto phone dialing system further comprises an info display communicatively linked to the service center for displaying the information of each of the phone service providers. Accordingly, the info display is arranged for displaying the calling rate of the respective phone service provider selected by the sorting selector when dialing the dialing number and the talking time of the call such that the user is able to determine the cost of the call. In addition, the user is able to search the provider database to find the lowest calling rate for the particular location and display on the info display before the user makes a call.

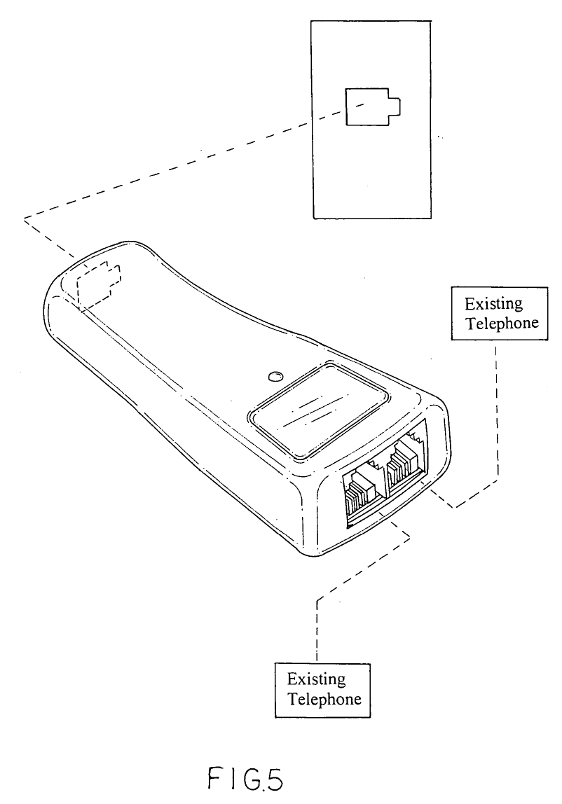

As shown in FIGS. 2 and 5, the auto phone dialing system of the present invention is embodied as an external device adapted for communicatively connecting with the existing telephone via a communication cable such that when the user dials the dialing number through the existing telephone, the phone number reader is adapted to read the dialing number and access the provider database to sort out the phone service providers therein. Then, the dialing signal is sent from the sorting selector to the existing telephone through the communication cable so as to dial the accessing number and the corresponding pin number of the respective phone service provider through the existing telephone.

As shown in FIG. 5, the auto phone dialing system of the present invention is embodied as a compact device having a phone inlet and at least a phone outlet communicatively linked to the phone jack and the existing telephone respectively via regular phone cables. Therefore, the installation of the auto phone dialing system is easy and simple that by directly connecting the dialing system to the existing telephone and the auto phone dialing system is ready to use.

Alternatively, the auto phone dialing system of the present invention can be embodied as an internal device built-in with the existing telephone to operatively control the dialing process of the existing telephone.

It is worth to mention that the auto phone dialing system of the present invention, which can be a web-based system, can be used as an Internet phone system, wherein the user is able to access the provider database through Internet, such that the sorting selector will select the phone service providers to make the call. In addition, the auto phone dialing system of the present invention can be utilized for the wireless phone service provider such that the user is able to make a call, especially an international call, by his or her mobile phone anywhere with the lowest calling rate.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An auto phone dialing system for multiple phone service providers, comprising:
a service center comprising a provider database for storing information of said phone service providers which contain a plurality of calling rates for different locations; and
a provider selection unit, which is communicatively linked to said service center, comprising a phone number reader adapted for reading a dialing number having a dialing code, and a sorting selector linked to said phone number reader and arranged in such a manner that when dialing said dialing number, said sorting selector is adapted for sorting out said information of said phone service providers in said provider database with respect to said dialing code and selecting one of said phone service providers to make a call at the lowest calling rate.

2. The auto phone dialing system, as recited in claim 1, wherein said information of each of said phone service provider further contains an accessing code of each of said phone service provider stored in said provider database, wherein when said call is made, said accessing code is automatically retrieved for communicatively accessing said respective phone service provider selected by said sorting selector.

3. The auto phone dialing system, as recited in claim 2, wherein said accessing code contains an accessing phone number and a corresponding pin number such that when said call is made, said accessing phone number and said corresponding pin number is automatically dialed when said respective phone service provider is selected by said sorting selector.

4. The auto phone dialing system, as recited in claim 1, wherein said dialing code contains a country code, an area code, and a phone number, wherein when said phone number reader reads said country code, said area code, and said phone number, said sorting selector automatically sorts out said phone service provider with the lowest calling rate with respect to said country code and said area code to make said call.

5. The auto phone dialing system, as recited in claim 2, wherein said dialing code contains a country code, an area code, and a phone number, wherein when said phone number reader reads said country code, said area code, and said phone number, said sorting selector automatically sorts out said phone service provider with the lowest calling rate with respect to said country code and said area code to make said call.

6. The auto phone dialing system, as recited in claim 3, wherein said dialing code contains a country code, an area code, and a phone number, wherein when said phone number reader reads said country code, said area code, and said phone number, said sorting selector automatically sorts out said phone service provider with the lowest calling rate with respect to said country code and said area code to make said call

7. The auto phone dialing system, as recited in claim 1, wherein said phone number reader comprises a memory module communicatively linked to said sorting selector for temporarily memorizing said dialing number to allow said sorting selector sorting out said phone service providers in said provider database and complete said dialing number simultaneously so as to speed up a dialing process thereof.

8. The auto phone dialing system, as recited in claim 3, wherein said phone number reader comprises a memory module communicatively linked to said sorting selector for temporarily memorizing said dialing number to allow said sorting selector sorting out said phone service providers in said provider database and complete said dialing number simultaneously so as to speed up a dialing process thereof.

9. The auto phone dialing system, as recited in claim 6, wherein said phone number reader comprises a memory module communicatively linked to said sorting selector for temporarily memorizing said dialing number to allow said sorting selector sorting out said phone service providers in said provider database and complete said dialing number simultaneously so as to speed up a dialing process thereof.

10. The auto phone dialing system, as recited in claim 1, further comprising info display communicatively linked to said service center for displaying said information of each of said phone service providers so as to present said calling rates of said phone service providers and a talking time of said call.

11. The auto phone dialing system, as recited in claim 6, further comprising info display communicatively linked to said service center for displaying said information of each of said phone service providers so as to present said calling rates of said phone service providers and a talking time of said call.

12. The auto phone dialing system, as recited in claim 9, further comprising info display communicatively linked to said service center for displaying said information of each of said phone service providers so as to present said calling rates of said phone service providers and a talking time of said call.

13. A method of dialing a phone number through an auto phone dialing system for multiple phone service providers, comprising the steps of:
(a) storing information of said phone service providers in a provider database, wherein said information of said phone service providers contains a plurality of calling rates for different locations of each of said phone service providers;
(b) receiving said phone number having a dialing code;
(c) sorting out said information of said phone service providers in said provider database with respect to said dialing code; and
(d) selecting one of said phone service providers to make a call with respect to said dialing code at the lowest calling rate.

14. The method, as recited in claim 13, wherein said information of each of said phone service provider further contains an accessing code of each of said phone service provider stored in said provider database, such that when said call is made, said accessing code is automatically retrieved for communicatively accessing said respective phone service provider.

15. The method, as recited in claim 14, wherein said accessing code contains an accessing phone number and a corresponding pin number, wherein the step (d) further comprises a step of automatically dialing said accessing phone number and said corresponding pin number to accessing said respective phone service provider when said call is made.

16. The method, as recited in claim 13, wherein said dialing code contains a country code, an area code, and a phone number, wherein the step (c) further comprise a step of sorting out said phone service provider with the lowest calling rate with respect to said country code and said area code to make said call.

17. The method, as recited in claim 15, wherein said dialing code contains a country code, an area code, and a phone number, wherein the step (c) further comprise a step of sorting out said phone service provider with the lowest calling rate with respect to said country code and said area code to make said call.

18. The method, as recited in claim 13, wherein the step (a) further comprises a step of updating said information of said phone service providers periodically.

19. The method, as recited in claim 17, wherein the step (a) further comprises a step of updating said information of said phone service providers periodically.

20. The method, as recited in claim 13, wherein the step (b) further comprise a step of temporarily memorizing said dialing number to allow said auto phone dialing system sorting out said phone service providers in said provider database and completing said dialing number simultaneously so as to speed up a dialing process thereof.

21. The method, as recited in claim 19, wherein the step (b) further comprise a step of temporarily memorizing said dialing number to allow said auto phone dialing system sorting out said phone service providers in said provider database and completing said dialing number simultaneously so as to speed up a dialing process thereof.

22. The method, as recited in claim 13, further comprising a step of displaying said information of each of said phone service providers to present said calling rates of said phone service providers and a talking time of said call.

23. The method, as recited in claim 21, further comprising a step of displaying said information of each of said phone service providers to present said calling rates of said phone service providers and a talking time of said call.

24. A method of making a call with the lowest calling rate from multiple phone service providers, comprising the steps of:
(a) contacting said phone service providers to obtain information thereof, wherein said information of said phone service providers contains a plurality of calling rates for different locations of each of said phone service providers;
(b) storing information of said phone service providers in a provider database;
(c) allowing a user to access said provider database when said user dials a phone number having a dialing code to make said call;
(d) sorting out said information of said phone service providers in said provider database with respect to said dialing code; and
(e) selecting one of said phone service providers to make said call with respect to said dialing code at the lowest calling rate.

25. The method, as recited in claim 24, wherein said information of each of said phone service provider further contains an accessing code of each of said phone service provider stored in said provider database, such that when said call is made, said accessing code is automatically retrieved for communicatively accessing said respective phone service provider.

26. The method, as recited in claim 25, wherein said accessing code contains an accessing phone number and a corresponding pin number, wherein the step (e) further comprises a step of automatically dialing said accessing phone number and said corresponding pin number to accessing said respective phone service provider when said call is made.

27. The method, as recited in claim 24, wherein said dialing code contains a country code, an area code, and a phone number, wherein the step (d) further comprise a step of sorting out said phone service provider with the lowest calling rate with respect to said country code and said area code to make said call.

28. The method, as recited in claim 26, wherein said dialing code contains a country code, an area code, and a phone number, wherein the step (d) further comprise a step of sorting out said phone service provider with the lowest calling rate with respect to said country code and said area code to make said call.

29. The method, as recited in claim 24, further comprising a step of automatically updating said information of said phone service providers periodically.

30. The method, as recited in claim 28, further comprising a step of automatically updating said information of said phone service providers periodically.
